(19) United States
(12) Patent Application Publication
(10) Pub. No.: US 2013/0171585 A1
(43) Pub. Date: Jul. 4, 2013

(54) APPARATUS FOR LIFTING MAXILLARY SINUS

(71) Applicant: Metal Industries Research&Development Centre, Kaohsiung (TW)

(72) Inventors: Ching-Chieh HUANG, Pingtung County (TW); Kai- Shi LUO, Tainan City (TW); Nan-Yu LIU, Kaohsiung City (TW); E-Hsung CHENG, Tainan City (TW); Shien-Nan KUO, Kaohsiung City (TW)

(73) Assignee: METAL INDUSTRIES RESEARCH&DEVELOPMENT CENTRE, KAOHSIUNG (TW)

(21) Appl. No.: 13/724,033

(22) Filed: Dec. 21, 2012

(30) Foreign Application Priority Data
Dec. 28, 2011 (TW) 100149129

(51) Int. Cl. A61C 8/00

(52) U.S. Cl. CPC A61C 8/0092
USPC 433/173

(57) ABSTRACT

An apparatus for lifting a maxillary sinus includes: a pillar, having a cutting blade and an engaging base; a transmission shaft, having a transmission base having a shape corresponding to that of the engaging base; an elastic element provided an elastic force between the engaging base and the transmission base; and a seal element, wrapping the engaging base, the elastic element and the transmission base. When the cutting blade encounters a drag force, the transmission base moves toward the engaging base until the transmission base and the engaging base are engaged with each other. When the drag force is decreased, the engaged transmission base and engaging base are separated from each other due to the elastic force of the elastic element.

### CROSS-REFERENCE TO RELATED APPLICATION

This application claims the benefit of Taiwan Patent Application No. 100149129, filed on Dec. 28, 2011, which is hereby incorporated by reference for all purposes as if fully set forth herein.

### BACKGROUND OF THE INVENTION

1. Field of Invention

The present invention relates to an apparatus for lifting a maxillary sinus, and in particular, to an apparatus for lifting a maxillary sinus capable of immediately stopping rotary cutting of a cutting blade when penetrating a cortical bone.

2. Related Art

In a dental implant operation, an implant can be tightly implanted into a gingival bone only after a bone cutting operation is performed on an alveolar bone and a round hole is drilled by a drill bit.

However, in current dental implant operations, when the height of the maxilla of a patient is insufficient, a maxillary sinus mucous membrane of the patient needs to be lifted, a sufficient amount of a bone needs to be transplanted, and then an implant is implanted, so as to ensure that the implant does not pierce the maxillary sinus mucous membrane. Such an operation is called as a maxillary sinus lifting operation. The maxillary sinus lifting operation is usually classified into an osteotome approach and a side windowing approach. Whether to use the osteotome approach or the side windowing approach depends on a remaining height of the alveolar bone. Traditionally, when the remaining height of the alveolar bone is less than 5 mm, the side windowing approach spending a longer time on treatment is used, and when the remaining height of the alveolar bone is equal to or more than 5 mm, the osteotome approach is used, so as to lift the maxillary sinus.

In the osteotome approach, a hammer is used to tap an osteotome, to cause fracture and piercing of a maxillary sinus floor on a last layer of cortical bone (with a thickness of about 1 to 2 mm) through hammering. An edge of a concave surface on the top of the osteotome is used to scrape a bone nearby, and deliver bone remnants to a maxillary sinus cavity. The bone remnants protect the maxillary sinus mucous membrane from being torn or pierced when the maxillary sinus is lifted. Meanwhile, the autogenous bone facilitates the growth of a new bone. No extra bone needs to be taken, which reduces the loss of the autogenous bone, and no artificial bone needs to be implanted, which reduces the cost. To prevent the maxillary sinus mucous membrane from being penetrated, a dentist needs to perform pre-operative planning through a computed tomography to check the height and mineral density of the bone. This approach usually relies on the experience and feeling of the dentist. Currently, a clinically excessive shock may cause sequelae of a patient, such as dizziness and cerebral concussion.

In view of the above clinical disadvantages, as shown in FIG. 1, an instrument for lifting a maxillary sinus is disclosed in US Patent Publication No. US20080293010. As shown in FIG. 2, an instrument for lifting a maxillary sinus disclosed in US Patent Publication No. US20100042222 is an improved design based on the instrument for lifting a maxillary sinus disclosed in US Patent Publication No. US20080293010. Referring to FIG. 1 and FIG. 2, the instrument for lifting a maxillary sinus includes a cylindrical drill bit 110 at a front end and a rod part 120 at a rear end. The rod part 120 may be connected to a hand piece, and a path 130 is provided in the middle of the cylindrical drill bit 110. A protrusion rod 140 is installed in the path 130 of the cylindrical drill bit 110, and is capable of free actuation along with a rotation shaft during rotation of the cylindrical drill bit 110. A spring 150 is disposed below the protrusion rod 140 and can push forward the protrusion rod 140. The operation method is the same as a common dental implant operation at first, and then the instrument disclosed in the patent is used to damage a last layer of cortical bone 210. During cutting, the protrusion rod 140 in the middle retracts under pressure, and the cortical bone is cut by a peripheral blade. After the last layer of cortical bone 210 is damaged, the protrusion rod 140 is pushed out as the pressure is decreased, thereby elevating a maxillary sinus mucous membrane 220, and avoiding the damage to the maxillary sinus mucous membrane 220. However, as a lateral blade continues rotating, the lateral blade may still be in contact with the maxillary sinus mucous membrane 220 and cause the damage to the maxillary sinus mucous membrane 220.

As shown in FIG. 1, as the area of a front end of the protrusion rod 140 is small, the stress is concentrated at one point. Consequently, the maxillary sinus mucous membrane may be damaged at the instant when the protrusion rod is pushed out. In the instrument for lifting a maxillary sinus disclosed in US Patent Publication No. US20080293010, the area of a front end of the protrusion rod 140 is small and the stress is concentrated at one point. Therefore, during contact with the maxillary sinus mucous membrane 220, the protrusion rod 140 may damage the maxillary sinus mucous membrane 220 as the stress of the protrusion rod 140 is concentrated at one point. Accordingly, as shown in FIG. 2, a diameter of the protrusion rod 140 in the middle is increased in the improved design, so as to increase a contact area and disperse the pressure. However, the problem of the damage to the maxillary sinus mucous membrane caused by continuous rotation of the lateral blade remains unsolved.

As shown in FIG. 3, a reamer instrument disclosed in US Patent Publication No. US20090142731 includes a cutting portion 310, a connection portion 320 extending below the cutting portion 310 and having a diameter smaller that of than the cutting portion, and a screw portion 330, which is a reversed screw, and is connected to the discharge portion 340. The cutting portion 310 includes a cutting blade 311. From a side view, a lowest point of the cutting blade 311 is at the rotational axis of the reamer instrument, and a highest point of the cutting blade 311 is at a circumference of the reamer instrument (therefore, the center of the cutting blade is concave). From a front view, the cutting blade 311 is perpendicular to the rotational axis of the reamer instrument (therefore, the cutting blade has a flat head). The cutting portion 310 further includes a discharge path 312, and a direction of the discharge path 312 is the same as a drilling direction. As shown in FIG. 4, when the reamer instrument is used to damage a last layer of cortical bone 410, the cutting blade 311 at a front end of the reamer instrument has a flat head (the concentration of the stress is decreased), and therefore, a maxillary sinus mucous membrane 420 is not directly pierced during rotation. In addition, a discharge mechanism of the reamer instrument is reverse discharge, and therefore bone remnants produced during upward cutting is accumulated upwardly, thereby protecting the cutting blade 311. Consequently, after damaging the last layer of cortical bone 410, the cutting blade 311 does not damage the maxillary sinus mucous membrane 420 during a lifting process, and can lift the maxillary sinus mucous membrane 420 safely and accurately by means of a rotation manner. However, the reamer instrument continuous rotating after damaging the cortical bone 410; despite the flat head design of the cutting blade at the front, the reamer instrument may possibly rub against and hence tear the maxillary sinus mucous membrane 420 due to the rotation.

Therefore, an apparatus for lifting a maxillary sinus is required to solve the preceding problem.

### SUMMARY OF THE INVENTION

An apparatus for lifting a maxillary sinus comprises: a pillar, having a top portion and a bottom portion, wherein the top portion is a cutting blade and the bottom portion is an engaging base; a transmission shaft, having a top portion, wherein the top portion is a transmission base and has a shape corresponding to that of the engaging base; an elastic element, wherein one end of the elastic element is physically connected to the engaging base, and the other end of the elastic element is physically connected to the transmission base, so as to provide an elastic force between the engaging base and the transmission base; and a seal element, wrapping the engaging base, the elastic element and the transmission base.

In the apparatus for lifting a maxillary sinus according to the present invention, when the cutting blade encounters a drag force, the transmission base moves toward the engaging base and presses the elastic element inside the seal element until the transmission base and the engaging base are engaged with each other, thereby driving the cutting blade to rotate and cut a cortical bone. When the drag force is decreased, the engaged transmission base and engaging base are separated from each other due to the elastic force of the elastic element, so that a rotary cutting of the cutting blade stops, thereby protecting a maxillary sinus mucous membrane. Therefore, during operation, the apparatus for lifting a maxillary sinus according to the present invention can immediately stop the rotary cutting of the cutting blade when penetrating the cortical bone, thereby avoiding the damage to the maxillary sinus mucous membrane and enhancing the security for patients. By an osteotome switch component, the apparatus for lifting a maxillary sinus according to the present invention can switch from a rotary cutting mode to an osteotome mode, thereby providing alternatives for a dentist to implement an operation.

In order to make the above and other objectives, features and advantages of the present invention more comprehensive, the present invention is described in detail below with reference to the accompanying drawings.

### BRIEF DESCRIPTION OF THE DRAWINGS

FIG. 1 is a sectional view of an instrument for lifting a maxillary sinus disclosed in US Patent Publication No. US20080293010;

FIG. 2 is a sectional view of an instrument for lifting a maxillary sinus disclosed in US Patent Publication No. US20100042222;

FIG. 3 is a perspectively view of an instrument for lifting a maxillary sinus disclosed in US Patent Publication No. US20090142731;

FIG. 4 is a sectional view of a use state of an instrument for lifting a maxillary sinus disclosed in US Patent Publication No. US20090142731;

FIG. 5 is a perspectively exploded view of an apparatus for lifting a maxillary sinus according to an embodiment of the present invention;

FIG. 6 (a) and FIG. 6 (b) are assembled sectional views of an apparatus for lifting a maxillary sinus according to an embodiment of the present invention;

FIG. 7 is a perspectively view of a pillar of an apparatus for lifting a maxillary sinus according to an embodiment of the present invention;

FIG. 8 is a perspectively view of a transmission shaft of an apparatus for lifting a maxillary sinus according to an embodiment of the present invention; and

FIG. 9(a) to FIG. 9(d) are sectional views of an operation procedure of an apparatus for lifting a maxillary sinus according to an embodiment of the present invention.

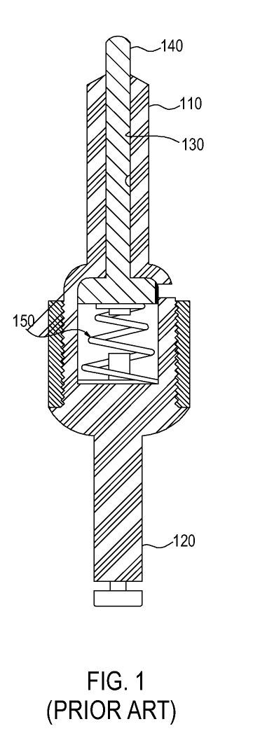

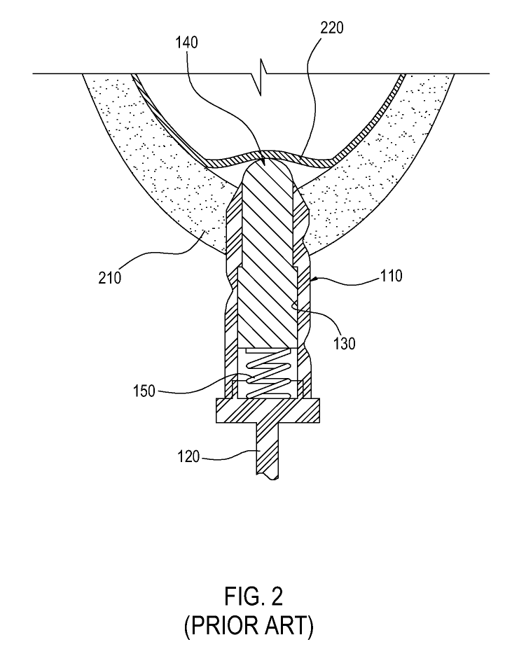

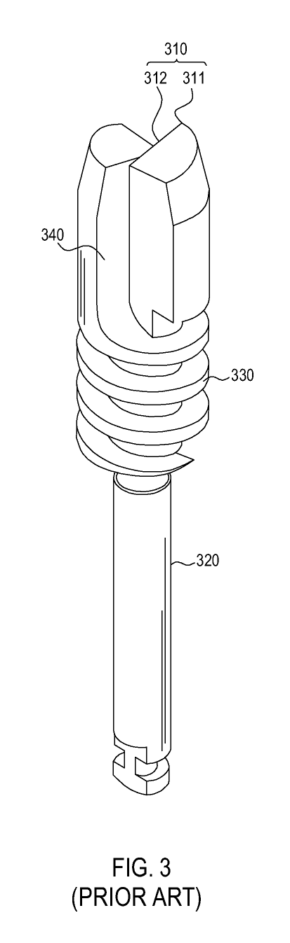

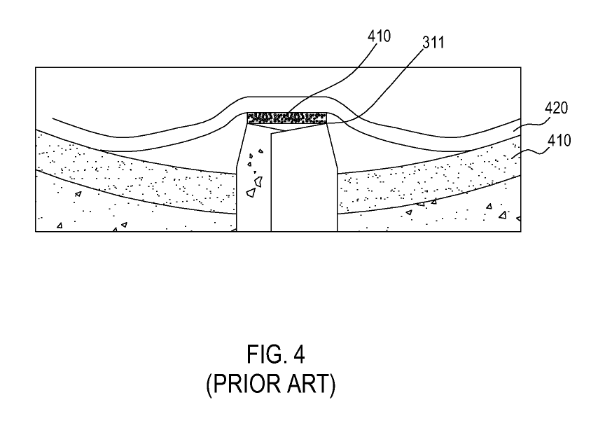

### DETAILED DESCRIPTION OF THE INVENTION

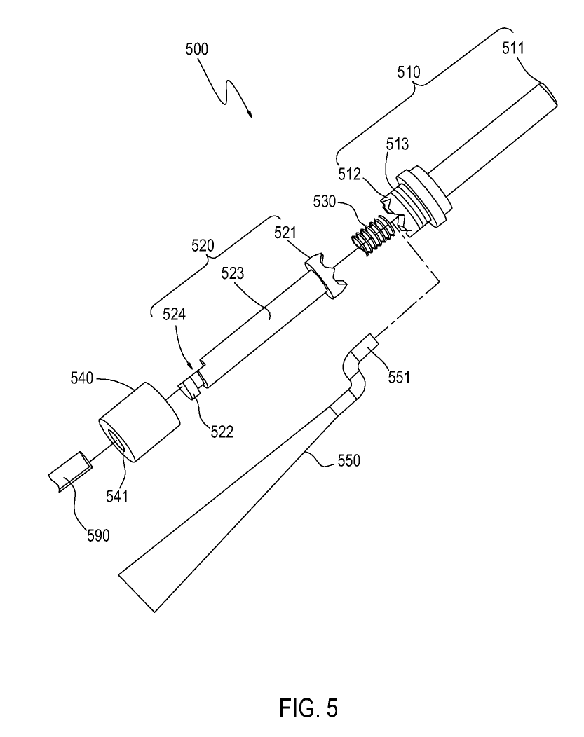

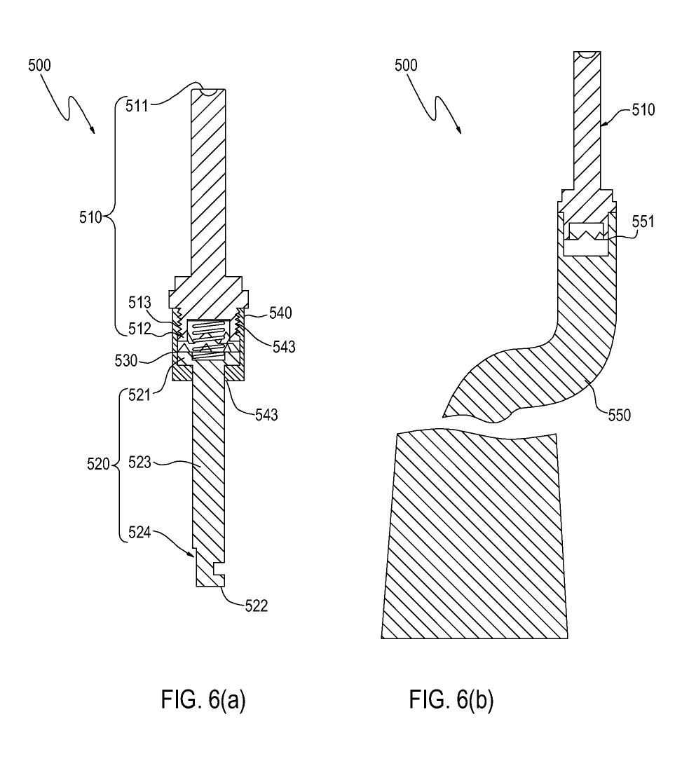

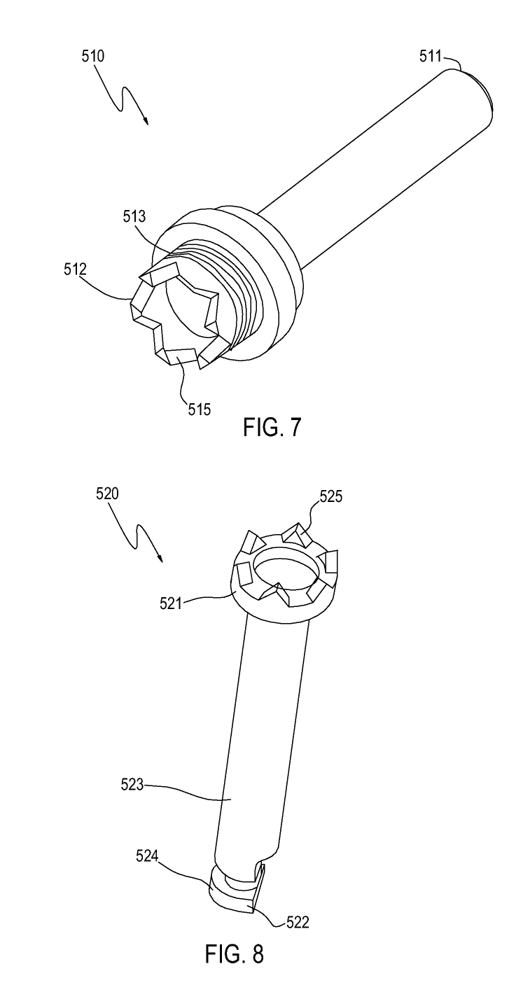

FIG. 5 is a perspectively exploded view of an apparatus for lifting a maxillary sinus according to an embodiment of the present invention. FIG. 6 (a) and FIG. 6 (b) are assembled sectional views of an apparatus for lifting a maxillary sinus according to an embodiment of the present invention. FIG. 7 is a perspectively view of a pillar of an apparatus for lifting a maxillary sinus according to an embodiment of the present invention. FIG. 8 is a perspectively view of a transmission shaft of an apparatus for lifting a maxillary sinus according to an embodiment of the present invention. Referring to FIG. 5 and FIG. 7, the apparatus 500 for lifting a maxillary sinus includes a pillar 510. The pillar 510 is cylindrical, and one end of the pillar 510 is a top portion. The top portion is a cutting blade 511 that has a function of cutting or damaging a cortical bone. From a side view, a lowest point of the cutting blade 511 is at a rotational axis, and a highest point of the cutting blade 511 is at a circumference. From a front view, a head of the cutting blade 511 is designed to be flat. Therefore, the cutting blade does not directly pierce a maxillary sinus mucous membrane during a rotation. The other end of the pillar 510 is a bottom portion, and the bottom portion is an engaging base 512. A screw thread 513 is provided on an external surface of the engaging base 512.

Referring to FIG. 5 and FIG. 8, one end of a transmission shaft 520 is a top portion. The top portion is a transmission base 521, and the transmission base 521 has a shape corresponding to that of the engaging base 512. The engaging base 512 and the transmission base 521 each include multiple saw teeth 515 and 525 for engagement. Preferably, the saw teeth 515 and 525 of the engaging base 512 and the transmission base 521 are annularly arranged. Each of the saw teeth 515 and 525 may be a three-dimensional isosceles triangle, wherein three angles of the three-dimensional isosceles triangle may be of 90 degrees, 45 degrees, and 45 degrees. The other end of the transmission shaft 520 is a bottom portion 524. The bottom portion 524 is provided with a flange 522, for being assembled on an electric dental hand piece 590. The transmission shaft 520 further includes a body 523. One end of the body 523 is physically connected to the transmission base 521, and the other end of the body 523 is physically connected to the bottom portion 524.

Referring to FIG. 5 and FIG. 6 (a), one end of an elastic element 530 is physically connected to the engaging base 512, and the other end of the elastic element 530 is physically connected to the transmission base 521, so as to provide an elastic force between the engaging base 512 and the transmission base 521. A seal element 540 wraps the engaging base 512, the elastic element 530, and the transmission base 521. The seal element 540 is of a circular tube shape, and a screw thread 543 is provided on an internal surface of one end of the seal element 540. The screw thread 543 on the internal surface of the seal element 540 is screw jointed with the screw thread 513 on the external surface of the engaging base 512. An opening 541 for the body 523 of the transmission shaft 520 to pass through is provided on the other end of the seal element 540. A diameter of the opening 541 is smaller than that of the transmission base 521 of the transmission shaft 520, and is greater than that of the body 523 of the transmission shaft 520, so as to prevent the transmission shaft 520 and the seal element 540 from being separated from each other, and to limit a protruding travel of the pillar 510.

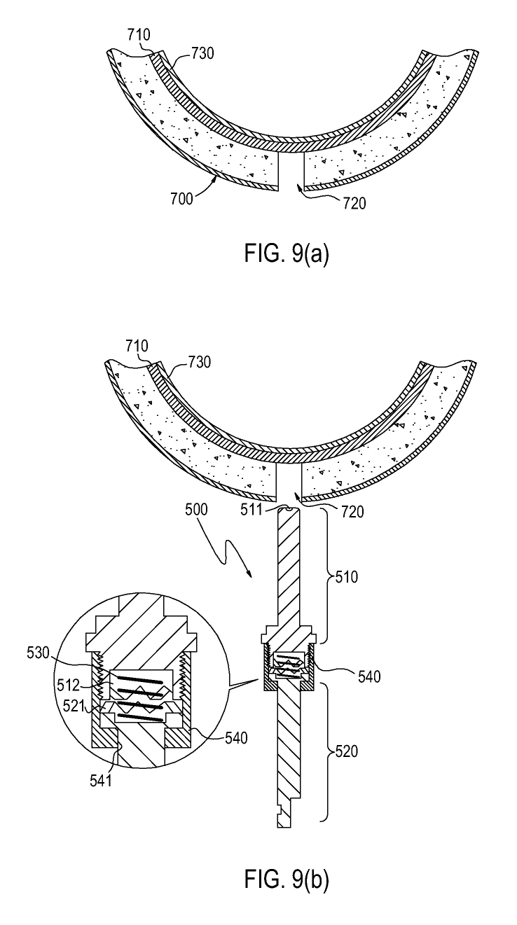

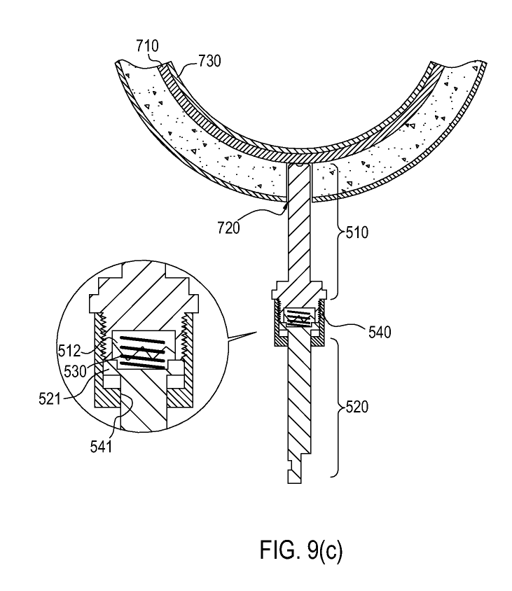

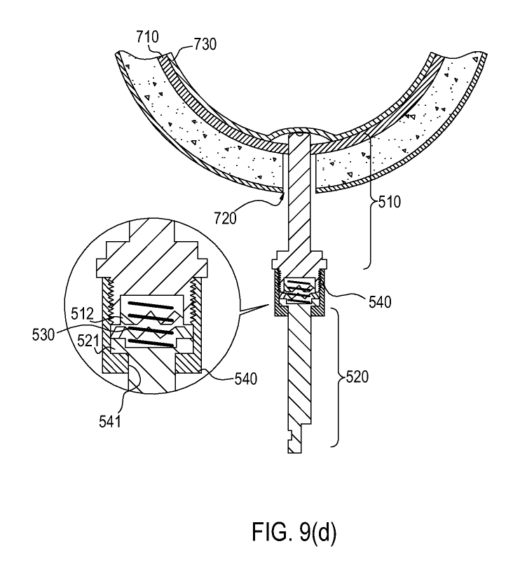

As shown in FIG. 9(a), before the apparatus 500 for lifting a maxillary sinus is used, a common dental implant drilling operation needs to be performed to drill a vertical hole 720 in an alveolar bone 700. The drilled hole shall be 1 mm to 2 mm away from the last layer of a cortical bone 710 in a depth direction. As shown in FIG. 9(b), the apparatus 500 for lifting a maxillary sinus is assembled on a dental implant hand piece, and is driven through the rotation of a motor of the dental implant hand piece, so that a dentist can carry out a treatment by means of a rotary cutting manner. As no drag force is applied to the cutting blade 511, the engaging base 512 is not engaged with the transmission base 521. Hence the transmission shaft 520 does not drive the cutting blade 511 located at the front thereof to rotate. As shown in FIG. 9(c), when the cutting blade 511 is in contact with the cortical bone 710, the cutting blade 511 encounters a drag force. Therefore, the transmission base 521 of the transmission shaft 520 moves toward the engaging base 512, presses the elastic element 530 located inside the seal element 540, and causes the saw teeth 525 of the transmission base 521 to be engaged with the saw teeth 515 of the engaging base 512, thereby driving the cutting blade 511 to rotate and cut the cortical bone 710. As shown in FIG. 9(d), after the cutting blade 511 pierces the cortical bone 710 (by a drilling or an elastic force), the drag force encountered by the cutting blade 511 is decreased. Hence, the engaged transmission base 521 and engaging base 512 are separated from each other due to the elastic force of the elastic element 530.

Specifically, since the drag force encountered by the cutting blade 511 is decreased, the elastic force of the elastic element 530 pushes out the pillar 510, and the cutting blade 511 of the pushed-out pillar 510 can elevate the maxillary sinus mucous membrane 730 by the pillar 510. After the pillar 510 is pushed out, the engagement between the transmission base 521 and the engaging base 512 is released, so that the rotary cutting of the cutting blade 511 stops, thereby protecting the maxillary sinus mucous membrane 730. After the pillar 510 is pushed out, since the diameter of the opening 541 of the seal element 540 is smaller than that of the transmission base 521, the seal element 540 is prevented from being separated from the transmission shaft 520 in use, and the pillar 510 is prevented from being pushed out for an excessive length to damage the maxillary sinus membrane 730.

Therefore, the apparatus for lifting a maxillary sinus according to the present invention can immediately stop the rotary cutting of the cutting blade when penetrating the cortical bone, thereby avoiding the damage to the maxillary sinus mucous membrane and enhancing the security of patients.

Moreover, referring to FIG. 6(b), in the apparatus for lifting a maxillary sinus according to the present invention, after the pillar 510 is separated from other components (that is, after the seal element 540, the elastic element 530 and the transmission shaft 520 are removed), the engaging base 512 of the pillar 510 can be combined with a joint end 551 of a manual osteotome switch component 550, providing an osteotome mode for a dentist to implement treatment.

Therefore, by an osteotome switch component, the apparatus for lifting a maxillary sinus according to the present invention can switch from a rotary cutting mode to an osteotome mode, thereby providing alternatives for a dentist to implement an operation.

In sum, the implementation manners or embodiments of the present invention for illustrating the technical solution to the problems are described above. However, the implementation manners or embodiments are not intended to limit the scope of the present invention. Any equivalent variation or modification that complies with the scope of the claims of the present invention or is made according to the scope of the present invention shall fall within the scope of the present invention.

What is claimed is:

1. An apparatus for lifting a maxillary sinus, comprising:
a pillar, having a top portion and a bottom portion, wherein the top portion is a cutting blade and the bottom portion is an engaging base;
a transmission shaft, having a top portion, wherein the top portion is a transmission base, and a shape of the transmission base is corresponds to that of the engaging base;
an elastic element, wherein one end of the elastic element is physically connected to the engaging base, the other end of the elastic element is physically connected to the transmission base, so as to provide an elastic force between the engaging base and the transmission base; and
a seal element, wrapping the engaging base, the elastic element, and the transmission base;
wherein when the cutting blade encounters a drag force, the transmission base moves toward the engaging base, presses the elastic element located inside the seal element, and causes the transmission base and the engaging base to be engaged with each other.

2. The apparatus for lifting a maxillary sinus according to claim 1, wherein when the drag force is decreased, the engaged transmission base and engaging base are separated due to the elastic force of the elastic element.

3. The apparatus for lifting a maxillary sinus according to claim 1, wherein the engaging base and the transmission base each comprise multiple saw teeth for engagement.

4. The apparatus for lifting a maxillary sinus according to claim 3, wherein the saw teeth of the engaging base and the transmission base are annularly arranged.

5. The apparatus for lifting a maxillary sinus according to claim 4, wherein the saw teeth are perspectively isosceles triangles.

6. The apparatus for lifting a maxillary sinus according to claim 5, wherein three angles of the perspectively isosceles triangle are of 90 degrees, 45 degrees, and 45 degrees respectively.

7. The apparatus for lifting a maxillary sinus according to claim 1, wherein the transmission shaft has a bottom portion for being assembled on an electric dental hand piece.

8. The apparatus for lifting a maxillary sinus according to claim 1, wherein a screw thread is provided on an internal surface of the seal element, a screw thread is provided on an external surface of the engaging base, and the screw thread of the internal surface of the seal element is screw jointed with that of the external surface of the engaging base.

9. The apparatus for lifting a maxillary sinus according to claim 1, wherein an opening is provided on the seal element, and a diameter of the opening is smaller than that of the transmission base of the transmission shaft and is greater than that of a body of the transmission shaft.

10. The apparatus for lifting a maxillary sinus according to claim 1, wherein after the seal element, the elastic element and the transmission shaft are removed, the engaging base of the pillar is used to be combined with a manual osteotome switch component.
